(19) United States
(12) Patent Application Publication
(10) Pub. No.: US 2023/0276000 A1
(43) Pub. Date: Aug. 31, 2023

(54) METHODS AND INTERNET OF THINGS SYSTEMS FOR MANAGING DATA OF CALL CENTERS OF SMART GAS

(71) Applicant: CHENGDU QINCHUAN IOT TECHNOLOGY CO., LTD., Chengdu (CN)

(72) Inventors: Zehua SHAO, Chengdu (CN); Haitang XIANG, Chengdu (CN); Xiaojun WEI, Chengdu (CN); Lei ZHANG, Chengdu (CN)

(73) Assignee: CHENGDU QINCHUAN IOT TECHNOLOGY CO., LTD., Chengdu (CN)

(21) Appl. No.: 18/312,602

(22) Filed: May 5, 2023

(30) Foreign Application Priority Data
Mar. 9, 2023 (CN) 202310220627.7

(51) Int. Cl. H04M 3/527; G16Y 10/35; G16Y 40/20

(52) U.S. Cl. CPC H04M 3/527; G16Y 10/35; G16Y 40/20

(57) ABSTRACT

The embodiments of the present disclosure provide methods for managing data of a call center of smart gas, executed by a processor in a smart gas management platform of an Internet of Things system for managing data of a call center of smart gas. The method may include: constructing call consultation data of a user to be troubleshooted based on consultation information of the user to be troubleshooted collected by a customer service from a user terminal through a network; generating a location result of a gas fault based on the call consultation data; and generating a fault handling plan based on the location result of the gas fault and sending the fault handling plan to the user terminal.

### CROSS-REFERENCE TO RELATED APPLICATION

This application claims priority of Chinese Patent Application No. 202310220627.7, filed on Mar. 9, 2023, the entire contents of which are hereby incorporated by reference.

### TECHNICAL FIELD

The present disclosure generally relates to the field of data management, and in particular, to methods and Internet of Things systems for managing data of a call center of smart gas.

### BACKGROUND

With development of society, the use of gas has penetrated all aspects of life, and gas users may inevitably encounter various problems in a process of using gas. Usually, when a fault occurs during the use of gas, the gas user may consult the related information about the gas fault through a customer service and find a solution to the gas fault. However, a base of gas users is far greater than a count of gas customer service staff, so when the gas users consult gas faults, there are often situations where the network is crowded, the line is busy, and even a lot of time is spent on consultations without effective solutions.

Therefore, it is desirable to provide methods for managing data of a call center of smart gas to help the gas users and the gas staff communicate efficiently, save labor resources, and help the gas users determine solutions in a timely and accurate manner to ensure the normal and safe use of gas.

### SUMMARY

One or more embodiments of the present disclosure provide a method for managing data of a call center of smart gas, executed by a processor in a smart gas management platform of an Internet of Things system for managing data of a call center of smart gas. The method may include: constructing call consultation data of a user to be troubleshooted based on consultation information of the user to be troubleshooted collected by a customer service from a user terminal through a network; generating a location result of a gas fault based on the call consultation data; and generating a fault handling plan based on the location result of the gas fault and sending the fault handling plan to the user terminal.

One of embodiments of the present disclosure provide an Internet of Things system for managing data of a call center of smart gas. The systems may include a smart gas user platform, a smart gas service platform, a smart gas management platform, a smart gas sensor network platform, and a smart gas object platform. The smart gas user platform may be configured to collect consultation information of a user to be troubleshooted from a user terminal through a network and send the consultation information to the smart gas management platform through the smart gas service platform. The smart gas management platform may be configured to construct call consultation data of the user to be troubleshooted based on the consultation information, generate a location result of a gas fault based on the call consultation data, generate a fault handling plan based on the location result of the gas fault, and send the fault handling plan to the user terminal. The smart gas service platform may be configured to send the fault handling plan to the smart gas user platform.

One or more embodiments of the present disclosure provide a non-transitory computer-readable storage medium storing computer instructions. When the computer instructions are executed by a computer, the method for managing data of a call center of smart gas as described in any one of the embodiments may be implemented.

### BRIEF DESCRIPTION OF THE DRAWINGS

The present disclosure is further illustrated in terms of exemplary embodiments. These exemplary embodiments are described in detail with reference to the drawings.

These embodiments are non-limiting exemplary embodiments, in which like reference numerals represent similar structures, wherein:

FIG. 1 is a schematic diagram illustrating an exemplary structure of a platform of an Internet of Things system for managing data of a call center of smart gas according to some embodiments of the present disclosure;

FIG. 2 is a flowchart illustrating an exemplary process for managing data of a call center of smart gas according to some embodiments of the present disclosure;

FIG. 3 is a flowchart illustrating an exemplary process for generating a location result based on call consultation data according to some embodiments of the present disclosure;

FIG. 4 is a schematic diagram illustrating an exemplary pre-location model according to some embodiments of the present disclosure;

FIG. 5 is a schematic diagram illustrating an exemplary location model according to some embodiments of the present disclosure; and

FIG. 6 is a flowchart illustrating an exemplary process for generating a location result based on gas association data and call consultation data according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

An Internet of Things system may be an information processing system that includes some or all of a user platform, a service platform, a management platform, a sensor network platform, and an object platform. The user platform may be a functional platform that realizes user perceptual information obtaining and control information generation. The service platform may realize connection between the management platform and the user platform and play functions of perceptual information service communication and control information service communication. The management platform may realize overall planning and coordination of connection and collaboration between various functional platforms (e.g., the user platform and the service platform). The management platform may gather information of an Internet of Things operation system and may provide functions of perception management and control management for the Internet of Things operation system. The sensor network platform may connect the management platform and the object platform to realize functions of perceptual information sensor communication and control information sensor communication. The object platform may be a functional platform for perceptual information generation and control information execution.

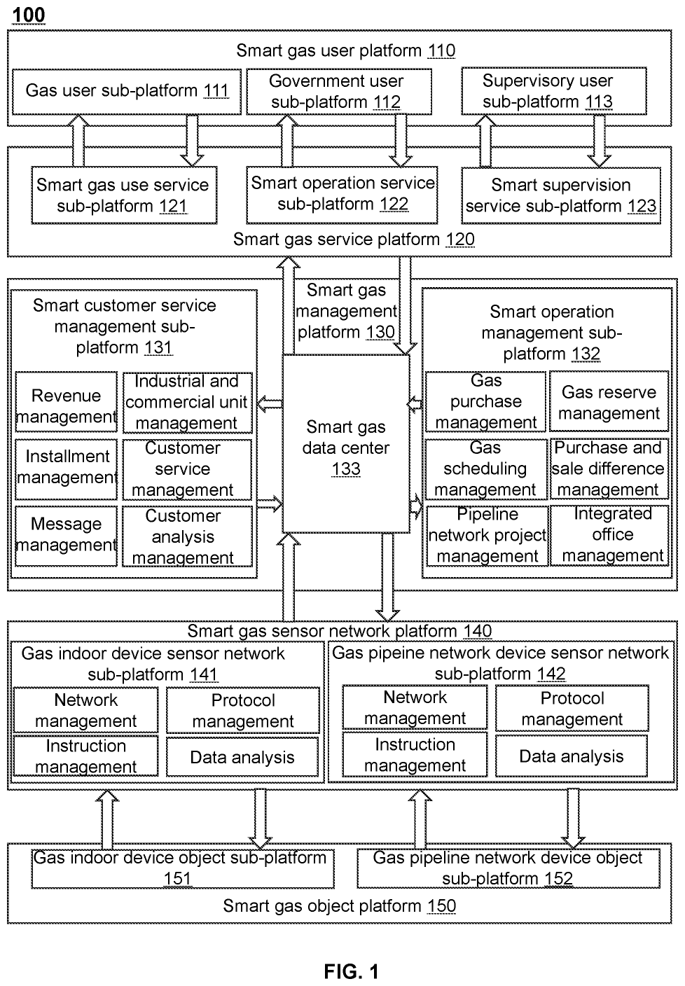

FIG. 1 is a schematic diagram illustrating an exemplary structure of a platform of an Internet of Things system for managing data of a call center of smart gas according to some embodiments of the present disclosure.

In some embodiments, the Internet of Things system 100 for managing data of a call center of smart gas may include a smart gas user platform 110, a smart gas service platform 120, a smart gas management platform 130, a smart gas sensor network platform 140, and a smart gas object platform 150.

The smart gas user platform 110 refers to a platform for obtaining consultation information (e.g., a query instruction, a gas user's answer to a question raised by a customer service, etc.) of a gas user and feeding back information (e.g., a fault handling plan, etc.) related to a gas fault to the user. In some embodiments, the smart gas user platform 110 may be configured as a terminal device (e.g., a mobile phone, a tablet, a computer, etc.). In some embodiments, the smart gas user platform 110 may interact with the smart gas service platform 120.

In some embodiments, the smart gas user platform 110 may include a gas user sub-platform 111, a government user sub-platform 112 and a supervisory user sub-platform 113.

The gas user sub-platform 111 refers to a platform that provides data related to gas use and the gas fault handling plan for the gas user (e.g., an industrial gas user, a commercial gas user, a general gas user, etc.). In some embodiments, the gas user sub-platform 111 may correspond to and interact with a smart gas use service sub-platform 121 to obtain a service of safe gas use. In some embodiments, the gas user sub-platform 111 may send the consultation information of the gas user to the smart gas use service sub-platform 121 and receive consultation information (e.g., a question raised by the customer service to the gas user) of the customer service uploaded by the smart gas use service sub-platform 121.

The government user sub-platform 112 refers to a platform that provides data related to gas operation for a government user. In some embodiments, the government user sub-platform 112 may correspond to and interact with a smart operation service sub-platform 122 to obtain a gas operation service. In some embodiments, the government user sub-platform 112 may issue a query instruction (e.g., a query instruction for the fault handling plan, a query instruction for management information of a call center agent, etc.) to the smart operation service sub-platform 122 and receive the information (e.g., the fault handling plan, the management information of the call center agent, etc.) related to the gas fault uploaded by the smart operation service sub-platform 122.

The supervisory user sub-platform 113 refers to a platform for supervising operation of the Internet of Things system 100 for managing data of a call center of smart gas for a supervisory user (e.g., a user of a security department, etc.). In some embodiments, the supervisory user sub-platform 113 may correspond to and interact with a smart supervision service sub-platform 123 to obtain a service of a safety supervision requirement.

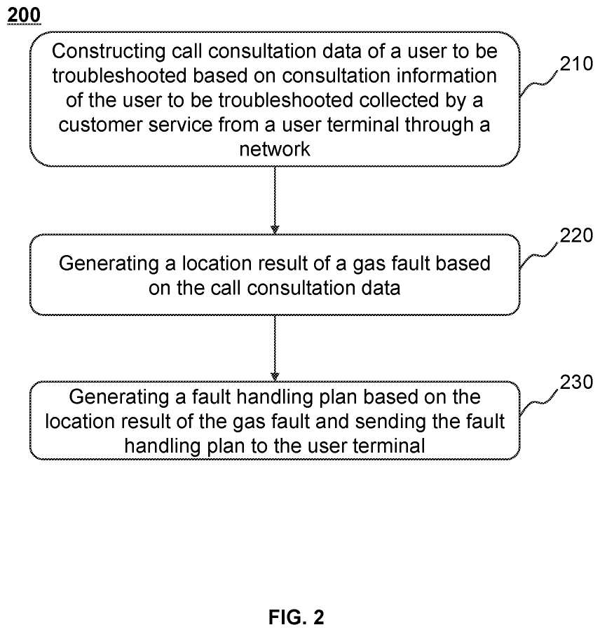

More description of the consultation information, the fault handling plan, the customer service may be found in FIG. 2 and its related descriptions.

The smart gas service platform 120 refers to a platform for receiving and transmitting data and/or information such as the consultation information, the query instructions, the fault handling plan, etc.

In some embodiments, the smart gas service platform 120 may include the smart gas use service sub-platform 121, the smart operation service sub-platform 122, and the smart supervision service sub-platform 123. In some embodiments, the smart gas use service sub-platform 121 may correspond to the gas user sub-platform 111 to provide the gas user with information related to a gas device. In some embodiments, the smart operation service sub-platform 122 may correspond to the government user sub-platform 112 to provide the government user with information related to gas operation. In some embodiments, the smart supervision service sub-platform 123 may correspond to the supervisory user sub-platform 113 to provide information related to safety supervision for the supervisory user.

In some embodiments, the smart gas service platform 120 may interact with the smart gas user platform 110. In some embodiments, the smart gas use service sub-platform 121 may receive the consultation information of the gas user sent by the gas user sub-platform 111 and upload the consultation information of the customer service to the gas user sub-platform 111. In some embodiments, the smart operation service sub-platform 122 may receive the query instruction issued by the government user sub-platform 112 and upload the information related to the gas fault to the government user sub-platform 112.

In some embodiments, the smart gas service platform 120 may interact with the smart gas management platform 130. In some embodiments, the smart gas service platform 120 may send the consultation information of the gas user and the query instruction to the smart gas data center 133 and receive the consultation information of the customer service and the information related to the gas fault uploaded by the smart gas data center 133.

The smart gas management platform 130 refers to a platform that overall plans and coordinates the connection and collaboration between various functional platforms, gathers all the information of the Internet of Things, and provides the functions of perception management and control management for the Internet of Things operation system. In some embodiments, the smart gas management platform 130 may be configured to construct call consultation data of a user to be troubleshooted based on consultation information of the user to be troubleshooted collected by the customer service from a user terminal through a network; generate a location result of the gas fault based on the call consultation data; and generate the fault handling plan based on the location result of the gas fault and send the fault handling plan to the user terminal.

More descriptions of the customer service, the user to be troubleshooted, the consultation information, the call consultation data, the location result of the gas fault, the fault handling plan, the manner for generating a location result of the gas fault and the fault handling plan may be found in FIG. 2-FIG. 6 and their related descriptions.

In some embodiments, the smart gas management platform 130 may include a smart customer service management sub-platform 131, a smart operation management sub-platform 132, and a smart gas data center 133.

The smart gas data center 133 may be configured to summarize and store all operation data of the Internet of Things system for managing data of a call center of smart gas. In some embodiments, the smart gas management platform 130 may perform information interaction with the smart gas service platform 120 and the smart gas sensor network platform 140 through the smart gas data center 133. In some embodiments, the smart gas data center 133 may receive the consultation information and the query instruction from the gas user issued by the smart gas service platform 120 and upload the consultation information of the customer service and the information related to the gas fault to the smart gas service platform 120. In some embodiments, the smart gas data center 133 may receive the consultation information of the gas user issued by the smart gas use service sub-platform 121 and upload the consultation information of the customer service to the smart gas use service sub-platform 121. In some embodiments, the smart gas data center 133 may feedback the fault handling plan to the smart gas use service sub-platform 121 and the smart operation service sub-platform 122. In some embodiments, the smart gas data center 133 may issue an instruction for obtaining the data (e.g., operation information of gas (indoor/pipeline network) devices in different periods of time and in different areas) related to the gas device to the smart gas sensor network platform 140 and receive the data related to the gas device uploaded by the smart gas sensor network platform 140.

In some embodiments, the smart customer service management sub-platform 131, the smart operation management sub-platform 132, and the smart gas data center 133 may be independent of each other. In some embodiments, the smart customer service management sub-platform 131 and the smart operation management sub-platform 132 may interact with the smart gas data center 133 bidirectionally. In some embodiments, the smart gas data center 133 may send the consultation information of the gas user and the data related to the gas device to the smart customer service management sub-platform 131 for analysis and processing and receive consultation information data (e.g., call consultation data, etc.) processed by the smart customer service management sub-platform 131. In some embodiments, the smart gas data center 133 may send the processed consultation information data and the data related to the gas device to the smart operation management sub-platform 132 and receive the fault handling plan processed by the smart operation management sub-platform 132.

In some embodiments, the smart customer service management sub-platform 131 may include a message management module and a customer service management module. The message management module may be configured to check information such as call, consultation, feedback, complaint, etc. of the gas user and send the above information to the customer service management module for corresponding reply processing. The customer service management model may be configured to access corresponding customer service and analyze and reply to the information fed back by the gas user. In some embodiments, the smart customer service management sub-platform 131 may also include other management modules (e.g., a revenue management module, an industrial and commercial unit management module, etc.), and different management modules may perform different functions, which is not limited herein.

In some embodiments, the smart operation management sub-platform 132 may include a pipeline network project management module. The pipeline network project management module may be configured to check work order information, staffing, progress of a pipeline network project and manage the pipeline network project. In some embodiments, the smart operation management sub-platform 132 may also include other management modules (e.g., a gas reserve management module, a gas scheduling management module, etc.), and different management modules may perform different functions, which is not limited herein.

The smart gas sensor network platform 140 refers to a platform for unified management of sensor communications. In some embodiments, the smart gas sensor network platform 140 may be configured as a communication network and a gateway. The smart gas sensor network platform 140 may use a plurality of sets of gateway servers or a plurality of sets of intelligent routers, which are not limited.

In some embodiments, the smart gas sensor network platform 140 may connect the smart gas management platform 130 and the smart gas object platform 150 to realize the functions of perceptual information sensor communication and control information sensor communication. In some embodiments, the smart gas sensor network platform 140 may interact with the smart gas object platform 150, issue an instruction for obtaining data related to the gas device to the smart gas object platform 150, and receive the data related to the gas device uploaded by the smart gas object platform 150. In some embodiments, the smart gas sensor network platform 140 may interact with the smart gas data center 133, receive the instruction for obtaining the data related to the gas device issued by the smart gas data center 133, and upload the data related to the gas device to the smart gas data center 133.

In some embodiments, the smart gas sensor network platform 140 may include a gas indoor device sensor network sub-platform 141 and a gas pipeline network device sensor network sub-platform 142. In some embodiments, the gas indoor device sensor network sub-platform 141 may correspond to a gas indoor device object sub-platform 151 and may be configured to obtain data related to an indoor device. In some embodiments, the gas pipeline network device sensor network sub-platform 142 may correspond to a gas pipeline network device object sub-platform 152 and may be configured to obtain data related to a pipeline network device.

The smart gas object platform 150 refers to a platform for obtaining the data related to the gas device. In some embodiments, the smart gas object platform 150 may be configured as various devices, for example, the indoor device (e.g., a gas meter or other metering devices of the gas user), the pipeline network device (e.g., a gas door station compressor, a pressure regulating device, a gas flow meter, a valve control device, etc.), a monitoring device (e.g., a temperature sensor, a pressure sensor, etc.) etc.

In some embodiments, the smart gas object platform 150 may interact with the smart gas sensor network platform 140, receive the instruction for obtaining the data related to the gas device issued by the smart gas sensor network platform 140, and upload the data related to the gas device to the smart gas sensor network platform 140.

In some embodiments, the smart gas object platform 150 may include the gas indoor device object sub-platform 151 and the gas pipeline network device object sub-platform 152. In some embodiments, the gas indoor device object sub-platform 151 may correspond to the gas indoor device sensor network sub-platform 141, obtain the data related to the indoor device, and upload the data related to the indoor device to the smart gas data center 133 through the gas indoor device sensor network sub-platform 141. In some embodiments, the gas pipeline network device object sub-platform 152 may correspond to the gas pipeline network device sensor network sub-platform 142, obtain the data related to the pipeline network device, and upload the data related to the pipeline network device to the smart gas data center 133 through the gas pipeline network device sensor network sub-platform 142.

In some embodiments of the present disclosure, the Internet of Things system 100 for managing data of a call center of smart gas is built through the Internet of Things functional architecture of five platforms, and the manner that general platform and sub-platform are arranged in combination is adopted, which can not only share the data processing pressure of the general platform, but also ensure the independence of each data, ensure the classified transmission, traceability of data, and the classification and processing of instructions, so that the structure and data processing of the Internet of Things clear and controllable, and facilitate the control and data processing of the Internet of Things.

FIG. 2 is a flowchart illustrating an exemplary process for managing data of a call center of smart gas according to some embodiments of the present disclosure. In some embodiments, the process 200 may be executed by a processor in the smart gas management platform 130. As shown in FIG. 2, the process 200 may include the following operations.

In 210, constructing call consultation data of a user to be troubleshooted based on consultation information of the user to be troubleshooted collected by a customer service from a user terminal through a network.

The customer service refers to a system or individual that undertakes gas user service work. For example, the customer service may be the customer service staff who are responsible for accepting inquiries from gas users and helping the gas users answer the questions. As another example, the customer service may be a customer service system that automatically responds to questions from the gas users.

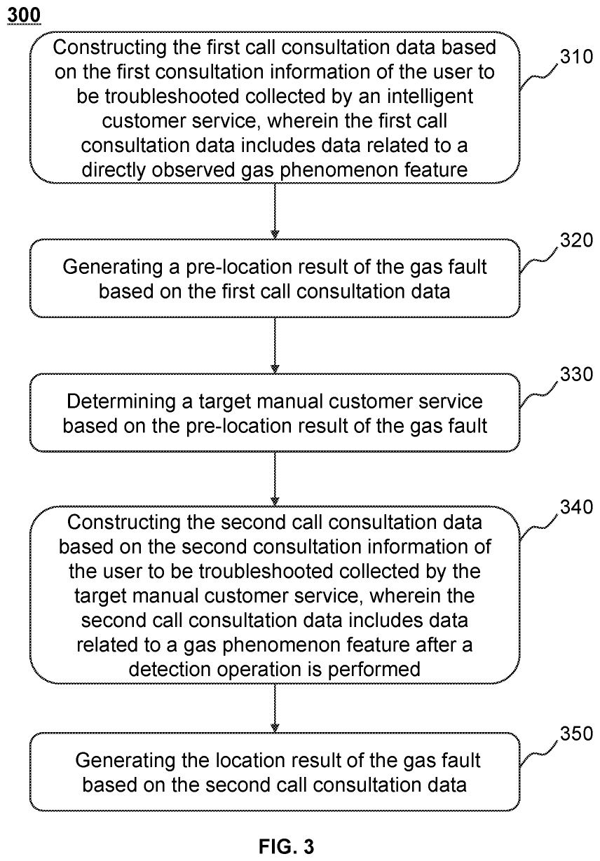

In some embodiments, the customer service may include an intelligent customer service and a manual customer service. More descriptions of the intelligent customer service and the manual customer service may be found in FIG. 3 and its related descriptions.

The user to be troubleshooted refers to a user who has a fault during gas use. For example, the user to be troubleshooted is an industrial gas user with unstable gas pressure. As another example, the user to be troubleshooted is an ordinary gas user whose gas stove cannot be used.

The consultation information refers to information contained in a dialogue between the customer service and the user to be troubleshooted about a related situation of the gas fault, and the consultation information may include the question asked by the customer service and the answer of the user to be troubleshooted. For example, the question asked by the customer service may be “Can gas ignite normally?” and the answer of the user to be troubleshooted may be “No, it will go out immediately after ignition.” The consultation information may be represented in various ways, for example, text information, voice information, image information, etc.

In some embodiments, the consultation information may include first consultation information and second consultation information. More descriptions of the first consultation information and the second consultation information may be found in FIG. 3 and its related descriptions.

In some embodiments, the processor in the smart gas management platform 130 may collect the consultation information from a user terminal through the network based on the customer service. In some embodiments, the consultation information may be stored in the smart gas data center 133 in real time. In some embodiments, the consultation information in the smart gas data center 133 may be updated periodically (e.g., every three years).

The call consultation data refers to data configured to summarize and characterize the consultation information. For example, the call consultation data may include a count of pieces of information, data on a type of the question asked by the customer service, a proportion of negative answers to the questions asked to answers of the user to be troubleshooted, etc. Corresponding to the consultation information, the call consultation data may include various forms of data, for example, text data, voice data, image data, etc.

In some embodiments, the call consultation data may be represented by a vector. The processor in the smart gas management platform 130 may preset a certain count (e.g., 20) of questions in advance. Each question corresponds to a fixed position of each element in the vector. A specific numerical value of the element may indicate the answer of the user to be troubleshooted to the question corresponding to the position of the element, and the representative meaning of the specific numerical value of the element may be preset manually or by the system. For example, the processor in the smart gas management platform 130 may preset 5 questions in advance. If the specific numerical value of the element of 0 indicates that there is no fault described in the question, the specific numerical value of the element of 1 indicates that the user to be troubleshooted feeds back a negative answer to the question, the specific numerical value of the element of 2 indicates that the user to be troubleshooted feeds back a positive answer to the question, and the specific value of the element of 3 indicates that the user to be troubleshooted feeds back a picture to the question, the call consultation data may be (0, 1, 2, 1, 3), which indicates that there is no fault described in the first question, and the user to be troubleshoot feeds back a negative answer to the second question, a positive answer to the third question, a negative answer to the fourth question, and a picture to the fifth question.

In some embodiments, the call consultation data may include first call consultation data and second call consultation data. More descriptions of the first call consultation data and the second call consultation data may be found in FIG. 3 and its related descriptions.

In some embodiments, the processor in the smart gas management platform 130 can process the consultation information and construct the call consultation data through various information processing technologies (e.g., a text data visualization technology, a speech conversion technology, an image recognition technology, etc.) and various feasible data construction manners.

In some embodiments, the processor in the smart gas management platform 130 may construct the first call consultation data based on the first consultation information, and construct the second call consultation data based on the second consultation information. More descriptions of the first consultation information, the second consultation information, the first call consultation data, and the second call consultation data may be found in FIG. 3 and its related descriptions.

In 220, generating a location result of a gas fault based on the call consultation data.

The location result of the gas fault refers to a gas fault that needs to be finally resolved. For example, the location result of the gas fault may be that a component of a gas cooker is damaged. As another example, the location result of the gas fault may be a gas pipeline leakage.

In some embodiments, the processor in the smart gas management platform 130 may process the call consultation data through modeling or various feasible data analysis manners (e.g., a correlation analysis, a discriminant analysis, etc.) to generate the location result of the gas fault.

In some embodiments, the processor in the smart gas management platform 130 may construct a feature vector based on the call consultation data. There are a plurality of manners to construct the feature vector based on the call consultation data. For example, the call consultation data may be represented by a vector, e.g., the feature vector p constructed based on the call consultation data (a, b, c, d, e). The call consultation data (a, b, c, d, e) may indicate that the user to be troubleshooted answers a to the first question, b to the second question, and b to the third question, d to the fourth question, and e to the fifth question.

The smart gas data center 133 may include a plurality of reference vectors and the location result of the gas fault corresponding to each reference vector of the plurality of reference vectors.

The reference vector may be constructed based on historical call consultation data, and the location result corresponding to the reference vector may be the location result of the gas fault of the corresponding historical call consultation data. A vector to be matched may be constructed based on the call consultation data of the current user to be troubleshooted. Construction manners of the reference vector and the vector to be matched may be found in the construction manner of the above feature vector.

In some embodiments, the processor in the smart gas management platform 130 may respectively calculate a vector distance (e.g., a cosine distance, etc.) between the reference vector and the vector to be matched and determine the location result corresponding to the vector to be matched. For example, a reference vector whose vector distance from the vector to be matched satisfies a preset condition may be used as a target vector, and a location result of a gas fault corresponding to the target vector may be used as a location result of a gas fault corresponding to the vector to be matched. The preset condition may be set according to a situation. For example, the preset condition may be that the vector distance is the smallest or the vector distance is smaller than a distance threshold, etc.

In some embodiments, the processor in the smart gas management platform 130 may generate the location result of the gas fault based on the first call consultation data and the second call consultation data.

More descriptions of the first call consultation data, the second call consultation data, and the location result of the gas fault generated based on the first call consultation data and the second call consultation data may be found in FIGS. 3-5 and their related descriptions.

In some embodiments, the processor in the smart gas management platform 130 may generate the location result of the gas fault based on the call consultation data and gas association data.

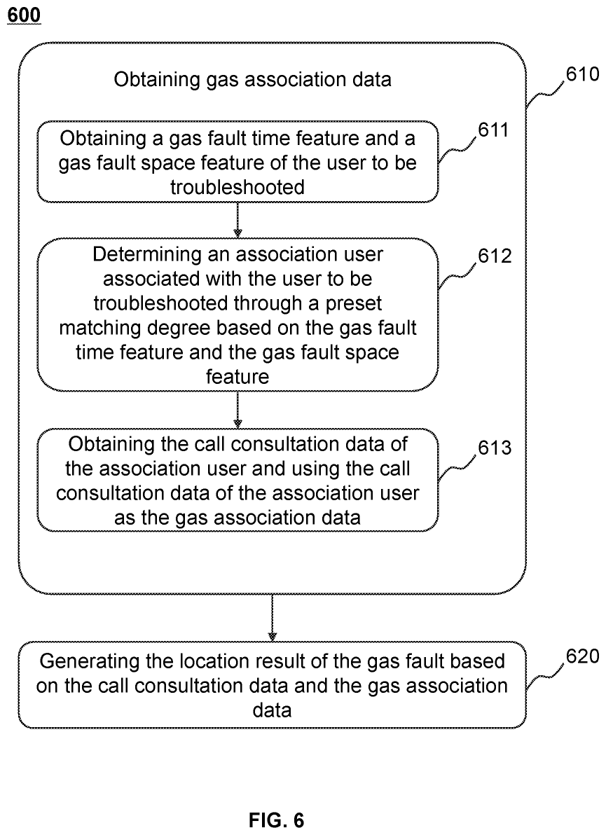

More descriptions of the gas association data and the generating the location result of the gas fault based on the call consultation data and the gas association data may be found in FIG. 6 and its related descriptions.

In 230, generating a fault handling plan based on the location result of the gas fault and sending the fault handling plan to the user terminal.

The fault handling plan refers to a solution to the gas fault corresponding to the location result of the gas fault, and the fault handling plan may be a solution for maintenance, repair, testing, etc. of a gas-related device. For example, if a gas fault phenomenon is “the gas cooker cannot ignite normally,” and the location result of the gas fault is “the component of the gas cooker is damaged,” the corresponding fault handling plan is “carry disassembly tools and replacement tools to the site to disassemble and replace the gas cooker.”

In some embodiments, the processor in the smart gas management platform 130 may directly generate the corresponding fault handling plan based on the location result of the gas fault. In some embodiments, the processor in the smart gas management platform 130 may establish a table based on a historical location result of the gas fault and a corresponding historical fault handling plan, determine a similar or identical historical location result based on a current location result of the gas fault through looking up the table, and use a historical fault handling plan corresponding to the similar or identical historical location result of the gas fault as the fault handling plan corresponding to the current location result of the gas fault. In some embodiments, the historical location result of the gas fault and corresponding historical fault handling plan may be stored in the smart gas data center 133.

In some embodiments of the present disclosure, the call consultation data may be constructed based on the consultation information of the user to be troubleshooted, the location result of the gas fault and the corresponding fault handling plan may be generated through the processing of the call consultation data, which can intelligently determine the fault of the gas pipeline network where the gas user is located, improve the efficiency of data processing and the accuracy of determining the fault handling plan, help gas users timely check the hidden dangers of gas use, and ensure the normal use of gas.

FIG. 3 is a flowchart illustrating an exemplary process for generating a location result based on call consultation data according to some embodiments of the present disclosure. In some embodiments, the process 300 may be executed by a processor in the smart gas management platform 130. As shown in FIG. 3, the process 300 may include the following operations.

In 310, constructing the first call consultation data based on the first consultation information of the user to be troubleshooted collected by the intelligent customer service, wherein the first call consultation data includes data related to a directly observed gas phenomenon feature.

The intelligent customer service refers to a system or individual that automatically completes gas customer service work through non-manual operations, for example, an intelligent customer service system, an intelligent customer service robot, an artificial Intelligence (AI) customer service agent, etc.

The first consultation information refers to information contained in a dialogue between the intelligent customer service and the user to be troubleshooted about a situation related to a directly observed gas phenomenon, and the first consultation information may include a question asked by the intelligent customer service related to a directly observed gas phenomenon feature and an answer of the users to be troubleshooted. For example, the question asked by the intelligent customer service may be “Is there any abnormal sound from the gas device?” and the answer of the user to be troubleshooted may be “There is an abnormal sound about 1 minute after the gas device is turned on.” The first consultation information may be expressed in various ways, for example, text information, voice information, image information, etc.

The first call consultation data refers to data configured to summarize and characterize the first consultation information. For example, the first call consultation data may include a count of pieces of first consultation information, data on a type of the question asked by the intelligent customer service, a proportion of negative answers to the questions asked to answers of the user to be troubleshooted, etc. Corresponding to the first consultation information, the first call consultation data may include various forms of data, for example, text data, voice data, image data, etc.

In some embodiments, the first call consultation data may be represented by a vector. The manner of representing the first call consultation data using the vector is the same as the manner of representing the call consultation data using the vector. More descriptions of representing the call consultation data using the vector may be found in FIG. 2 and its related descriptions.

In some embodiments, the processor in the smart gas management platform 130 may obtain the first consultation information by inquiring the user to be troubleshooted based on a first question set through the intelligent customer service. The processor in the smart gas management platform 130 may construct the first call consultation data based on the first consultation information, wherein the first question set is determined based on a preset question.

The first question set refers to a set of questions related to the directly observed gas phenomenon features. For example, the first question set may include “Can the gas ignite normally?” “What is the color of the fireworks of the gas?” “Is there any abnormal sound from the gas device?” etc.

In some embodiments, the first question set may be determined based on preset questions, and the preset questions may be determined according to prior experience (e.g., historical troubleshooting experience, etc.) or historical questions. For example, accurate historical location results may be obtained from the smart gas data center 133, questions related to the directly observed gas phenomenon features used when the historical location results are generated are obtained, and these questions are used as the preset questions. In some embodiments, the first question set and preset questions may be stored in the smart gas data center 133. In some embodiments, the first question set and the preset questions may be updated periodically (e.g., every year).

In some embodiments, the processor in the smart gas management platform 130 may process the first consultation information and construct the first call consultation data through various information processing technologies (e.g., a text data visualization technology, a speech conversion technology, an image recognition technology, etc.) and various feasible data construction manners.

In 320, generating a pre-location result of the gas fault based on the first call consultation data.

The pre-location result of the gas fault refers to for a plurality of possible gas faults, the pre-location result of the gas fault may include a probability of occurrence corresponding to each gas fault. The pre-location result of the gas fault may be represented by a vector, each element in the vector may correspond to a gas fault, and a value of each element may be the probability that a current abnormality is caused by the gas fault, that is, the probability of occurrence of the gas fault. Merely by way of example, the pre-location result of the gas fault may be (0.2, 0.3, 0.4), indicating that the occurrence probability of “gas cooker component damage” is 20%, the probability of occurrence of “gas pipeline leakage” is 30%, and the probability of occurrence of “gas meter aging” is 40%.

In some embodiments, the processor in the smart gas management platform 130 may process the first call consultation data through modeling or various feasible data analysis manners (e.g., a correlation analysis, a discriminant analysis, etc.) to generate the pre-location result of the gas fault.

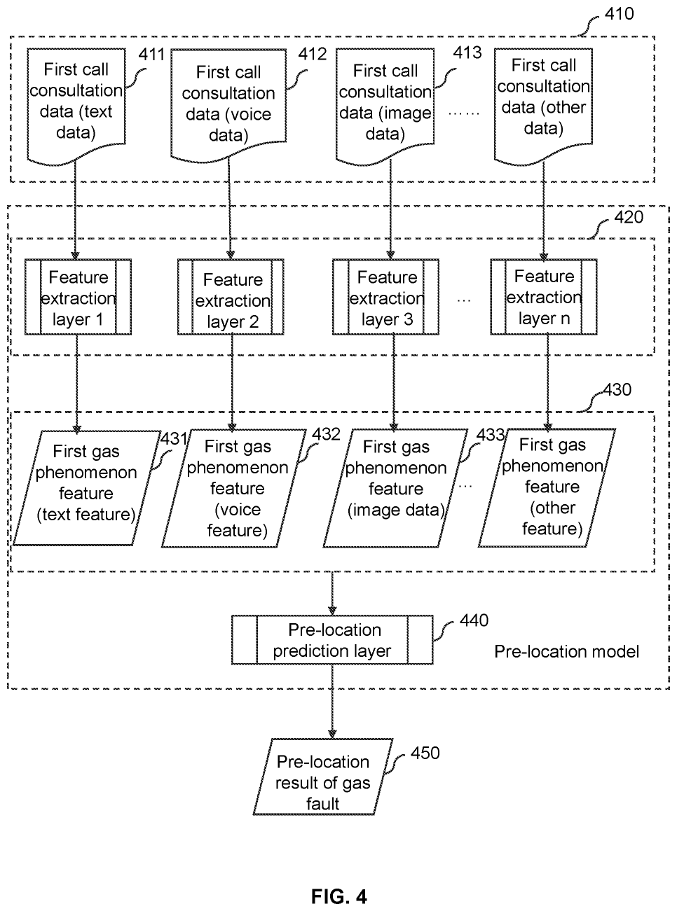

In some embodiments, the processor in the smart gas management platform 130 may process the first call consultation data through a pre-location model to generate the pre-location result of the gas fault. More descriptions of the pre-location model may be found in FIG. 4 and its related descriptions.

In 330, determining a target manual customer service based on the pre-location result of the gas fault.

The manual customer service refers to an individual who completes the gas customer service work through a manual operation, for example, an ordinary operator, a technician, a senior expert, etc.

The target manual customer service refers to a specific manual customer service that matches the pre-location result of the gas fault. For example, according to each type of the gas fault (e.g., a type of a gas terminal fault, a type of a gas household pipeline fault, a type of gas upstream transmission fault, etc.), a set of preset manual customer service is accordingly set as the target manual customer service corresponding to the type of fault.

In some embodiments, the processor in the smart gas management platform 130 may generate a gas location complexity based on the pre-location result of the gas fault, and determine the matching target manual customer service based on the gas location complexity.

The gas location complexity refers to a complexity of generating location result of the gas fault. The higher the gas location complexity, the more difficult it is to generate location result of the gas fault.

In some embodiments, the gas location complexity may be generated based on the pre-location result of the gas fault. For example, the pre-location result of the gas fault may be (0.1, 0.1, 0.05), and the probability of occurrence of each gas fault is relatively uniform, so the gas location complexity is relatively large. As another example, the pre-location result of the gas fault may be (0.01, 0.05, 0.7), where 0.7 is obviously greater than other values, so it is relatively clear to take the gas fault with the probability of occurrence of 70% as the location result of the gas fault, and the gas location complexity is relatively small.

In some embodiments, the gas location complexity may be obtained by quantitatively calculating the pre-location result of the gas fault. For example, a sum of a difference between a maximum value of the element and other values of the elements in the vector of the pre-location result of the gas fault may be calculated, and the calculation result may be used as the gas location complexity. As another example, a difference between “variance before the maximum value is removed” and “variance after the maximum value is removed” of the elements in the vector of the pre-location result of the gas fault may be calculated, and the calculation result may be used as the gas location complexity.

In some embodiments, the gas location complexity may also be related to a historical gas fault distribution of the user to be troubleshooted.

The historical gas fault distribution refers to a distribution of types of gas faults that have occurred in the history of the user to be troubleshooted. The more single the types of gas faults that have occurred in the history of the user to be troubleshooted, the smaller the gas location complexity. The more complex the types of gas faults that have occurred in the history of the user to be troubleshooted, the larger the gas location complexity.

In some embodiments of the present disclosure, the historical gas fault distribution of the user to be troubleshooted may be introduced to determine the gas location complexity, and then determine the target manual customer service for the user to be troubleshooted, which can fully combine the specific actual situation of the user to be troubleshooted, improve the accuracy of gas location complexity, and ensure that the target manual customer service for the user to be troubleshooted meets the actual problems that need to be solved.

In some embodiments, the processor in the smart gas data center 133 may arrange the matching target manual customer service for the user to be troubleshooted according to the gas location complexity. For example, the gas location complexity may be divided into different intervals, and according to each gas location complexity interval, a set of preset manual customer service may be set accordingly, and determine an interval to which the gas location complexity generated based on the pre-location result belongs, and use a manual customer service corresponding to the interval as the target manual customer service.

In 340, constructing the second call consultation data based on the second consultation information of the user to be troubleshooted collected by the target manual customer service, wherein the second call consultation data includes data related to a gas phenomenon feature after a detection operation is performed.

The second consultation information refers to information contained in a dialogue between the target manual customer service and the user to be troubleshooted about a situation related to a gas phenomenon after the detection operation is performed. The second consultation information may include a question asked by the target manual customer service related to the gas phenomenon feature after the detection operation is performed and an answer of the users to be troubleshooted. For example, the question asked by the target manual customer service may be “use a brush dipped in soapy water to smear positions A, B, and C of the gas device and observe whether the smeared position is foamed.” The answer of the user to be troubleshooted may be “bubbles at position A, but no bubbles at positions B and C.” The second consultation information may be expressed in various ways, for example, the text information, the voice information, the image information, etc.

The second call consultation data refers to data configured to summarize and characterize the second consultation information. For example, the second call consultation data may include a count of pieces of second consultation information, data on a type of the question asked by the target human customer service, a proportion of negative answers to the questions asked to answers of the user to be troubleshooted, etc. Corresponding to the second consultation information, the second call consultation data may include various forms of data, for example, the text data, the voice data, the image data, etc.

In some embodiments, the second call consultation data may be represented by a vector. The manner of representing the second call consultation data using the vector may be the same as the manner of representing the call consultation data using the vector. More descriptions of representing the call consultation data using the vector may be found in FIG. 2 and its related descriptions.

In some embodiments, the processor in the smart gas management platform 130 may obtain the second consultation information by inquiring the user to be troubleshooted based on a second question set through the target manual customer service and construct the second call consultation data based on the second consultation information, wherein the second question set is related to a feature of a gas terminal of the user to be troubleshooted.

The second question set refers to a set of questions related to the gas phenomenon features after the detection operation is performed. For example, the second question set may include “use a brush dipped in soapy water to smear positions A, B, and C of the gas device, and observe whether the smeared position is foamed.” “open/close the indoor windows, and observe the color change of the fireworks of the gas,” “take a picture of the switch position of the gas device and upload it to the system,” etc.

In some embodiments, the second question set may be related to the feature of the gas terminal of the user to be troubleshooted, and the feature of the gas terminal may be configured to represent a type of the gas terminal. For example, the type of the gas terminal may include a gas stove, a boiler, a welding gun, etc. The processor in the smart gas management platform 130 may set a corresponding second question set according to the feature of the gas terminal of the user to be troubleshooted. For example, when the feature of the gas terminal of the user to be troubleshooted is the gas stove, the second question set may be a question set related to features related to the gas stove.

In some embodiments, the questions in the second question set may be determined according to prior experience (e.g., historical troubleshooting experience, etc.) or historical questions. For example, accurate historical location result may be obtained from the smart gas data center 133, questions related to the gas phenomenon feature after the detection operation is performed used when the historical location results are generated may be obtained, and these questions may be used as the questions in the second question set. In some embodiments, the second question set may be stored in the smart gas data center 133. In some embodiments, the second question set may be updated periodically (e.g., every year).

In some embodiments, the processor in the smart gas management platform 130 may process the second consultation information and construct the second call consultation data through various information processing technologies (e.g., the text data visualization technology, the speech conversion technology, the image recognition technology, etc.) and various feasible data construction manners.

In 350, generating the location result of the gas fault based on the second call consultation data.

More descriptions of the location result may be found in FIG. 2 and its related descriptions.

In some embodiments, the processor in the smart gas management platform 130 may process the second call consultation data through modeling or various feasible data analysis manners (e.g., the correlation analysis, the discriminant analysis, etc.) to generate the location result of the gas fault.

In some embodiments, the processor in the smart gas management platform 130 may construct a feature vector based on the second call consultation data. There are a plurality of manners to construct the feature vector based on the second call consultation data. For example, the second call consultation data may be represented by a vector, e.g., the feature vector p constructed based on the second call consultation data (a, b, c, d, e). The call consultation data (a, b, c, d, e) may indicate that the user to be troubleshooted answers a to the first question, b to the second question, and b to the third question, d to the fourth question, and e to the fifth question.

The smart gas data center 133 may include a plurality of reference vectors and the location result of the gas fault corresponding to each reference vector of the plurality of reference vectors.

The reference vector may be constructed based on historical second call consultation data, and the location result of the gas fault corresponding to the reference vector may be the location result of the gas fault of the corresponding historical second call consultation data. A vector to be matched may be constructed based on the second call consultation data of the current user to be troubleshooted. Construction manners of the reference vector and the vector to be matched may be found in the construction manner of the above feature vector.

In some embodiments, the processor in the smart gas management platform 130 may respectively calculate a vector distance (e.g., the cosine distance, etc.) between the reference vector and the vector to be matched and determine the location result corresponding to the vector to be matched. For example, a reference vector whose vector distance from the vector to be matched satisfies a preset condition is used as a target vector, and a location result of a gas fault corresponding to the target vector may be used as a location result of a gas fault corresponding to the vector to be matched. The preset condition may be set according to a situation. For example, the preset condition may be that the vector distance is the smallest or the vector distance is smaller than a distance threshold, etc.

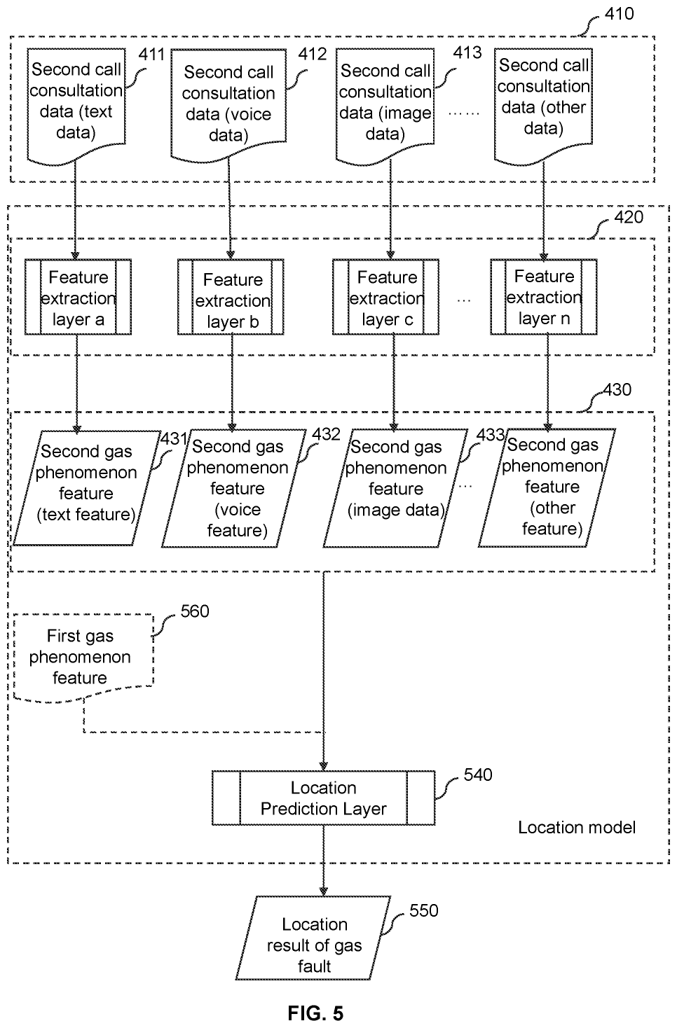

In some embodiments, the processor in the smart gas management platform 130 may process the second call consultation data through a location model to generate the location result of the gas fault. More descriptions of the location model may be found in FIG. 5 and its related descriptions.

In some embodiments of the present disclosure, the first call consultation data may be constructed based on the first question set, and the second consultation data may be constructed based on the second question set, which can determine the main fault of the user to be troubleshooted step by step, gradually narrow the scope of troubleshooting, and improve the accuracy of the location result for determining the gas fault. The first call consultation data may be constructed through the first consultation information collected by the intelligent customer service, and the pre-location result of the gas fault may be determined based on the first call consultation data, and the target manual customer service may further be determined based on the pre-location result of the gas fault, which can ensure the rationality of the target manual customer service for the user to be troubleshooted, and at the same time avoid the abuse of manual customer service, effectively reduce the waste of human resources, and improve the efficiency of problem handling.

It should be noted that the above description about the process 200 and the process 300 is merely for illustration and description, and not intended to limit the scope of application of the present disclosure. For those skilled in the art, various modifications and changes may be made to the process 200 and the process 300 under the guidance of the present disclosure. However, these modifications and changes are still within the scope of the present disclosure.

FIG. 4 is a schematic diagram illustrating an exemplary pre-location model according to some embodiments of the present disclosure.

In some embodiments, a processor in the smart gas data center 133 may process first call consultation data through the pre-location model to generate a pre-location result of a gas fault.

The pre-location model refers to a model used to generate the pre-location result of the gas fault. In some embodiments, the pre-location model may process the first call consultation data 410 to obtain the pre-location result 450 of the gas fault.

As shown in FIG. 4, the pre-location model may include a feature extraction layer 420 and a pre-location prediction layer 440.

In some embodiments, the feature extraction layer 420 may process the first call consultation data 410 to obtain a first gas phenomenon feature 430. In some embodiments, the feature extraction layer 420 may include various feasible neural network models such as a graph neural network (GNN) model, a convolutional neural network (CNN) model, a deep neural network (DNN) model, or the like, or any combination thereof.

In some embodiments, the feature extraction layer 420 may include a plurality of feature extraction layers (e.g., a feature extraction layer 1, a feature extraction layer n, etc.), and different feature extraction layers may respectively process the first call consultation data 410 of different data types to obtain the first gas phenomenon feature 430 of different feature types. For example, the feature extraction layer 1 may process first call consultation data 411 whose data type is text data and obtain a first gas phenomenon feature (text feature) 431.

As shown in FIG. 4, an input of the feature extraction layer 420 may include the first call consultation data 410 of different data types (e.g., the first call consultation data (text data) 411, first call consultation data (voice data) 412, first call consultation data (image data) 413, etc.).

An output of the feature extraction layer 420 may include first gas phenomenon features 430 of different feature types (e.g., the first gas phenomenon feature (text feature) 431, a first gas phenomenon feature (voice feature) 432, and a first gas phenomenon feature (image feature) 433, etc.).

The first gas phenomenon feature 430 refers to a feature reflecting data information contained in the first call consultation data 410. The first gas phenomenon feature 430 may be represented by a vector, and different elements in the vector represent different features in the first call consultation data. For example, the first gas phenomenon feature 430 may be (a, b, c). a represents a count of pieces of the first consultation information, b represents a type of a question asked by a customer service, and c represents a proportion of negative answers to the questions asked to answers of the user to be troubleshooted.

More descriptions of the first consultation information and the first call consultation data may be found in FIG. 3 and its related descriptions thereof.

In some embodiments, the pre-location prediction layer 440 may process the first gas phenomenon feature 430 to obtain the pre-location result 450 of the gas fault. In some embodiments, the pre-location prediction layer 440 may include various feasible neural network models such as the graph neural network (GNN) model, the convolutional neural network (CNN) model, the deep neural network (DNN) model, or the like, or any combination thereof.

In some embodiments, the pre-location prediction layer 440 may process the plurality of first gas phenomenon features 430 of different feature types to obtain the pre-location result 450 of the gas fault.

As shown in FIG. 4, an input of the pre-location prediction layer 440 may include the first gas phenomenon features 430 of different feature types (e.g., the first gas phenomenon feature (text feature) 431, the first gas phenomenon feature (voice feature) 432, and the first gas phenomenon feature (image feature) 433).

An output of the pre-location prediction layer 440 may include the pre-location result 450 of the gas fault. For example, the output pre-location result 450 of the gas fault may be (0.2, 0.3, 0.4), which indicates the probability of occurrence of “gas cooker component damage” is 20%, the probability of occurrence of “gas pipeline leakage” is 30%, and the probability of occurrence of “gas meter aging” is 40%.

More descriptions of the pre-location result of the gas fault may be found in FIG. 3 and its related descriptions.

In some embodiments, the output of the feature extraction layer 420 may be the input of the pre-location prediction layer 440, and the pre-location model may be obtained through joint training of the feature extraction layer 420 and the pre-location prediction layer 440.

In some embodiments, first sample data of the joint training may include sample first call consultation data of different data types, and a first label corresponding to the first sample data may be a pre-location result of a sample gas fault. The sample first call consultation data may be represented by a vector. The dimension of the vector may be set in advance manually or by the system. Each element in the vector corresponds to a question. A specific numerical value of the element may indicate the answer of the user to be troubleshooted to the question, and if there is no such question, it is represented by 0. More descriptions of representing the first call consultation data using the vector may be found in FIG. 2, FIG. 3 and their related descriptions. The first sample data may be obtained based on historical data, and the first label may be determined by manual labeling or automatic labeling.

During training, the sample first call consultation data of different data types may be input into a corresponding initial feature extraction layer to obtain the first gas phenomenon features of different feature types output by the corresponding initial feature extraction layer. The first gas phenomenon features of different feature types may be input into an initial pre-location prediction layer as training sample data to obtain the pre-location result of the gas fault output by the initial pre-location prediction layer. A loss function may be constructed based on the pre-location result of the sample gas fault and the pre-location result of gas fault output by the pre-location prediction layer, and parameters of the feature extraction layer and the pre-location prediction layer may be updated synchronously. Through parameter updating, a trained feature extraction layer and pre-location prediction layer may be obtained.

In some embodiments of the present disclosure, the first call consultation data may be processed through the pre-location model to obtain the pre-location result of the gas fault, which can ensure the accuracy of the generated pre-location result of the gas fault. Different feature extraction layers may process the first call consultation data of different data types, which can improve the efficiency of the pre-location model in processing large amounts of data.

FIG. 5 is a schematic diagram illustrating an exemplary location model according to some embodiments of the present disclosure.

In some embodiments, a processor in the smart gas data center 133 may process second call consultation data through the location model to generate a location result of gas fault.

The location model refers to a model used to generate the location result of the gas fault. In some embodiments, the location model may process the second call consultation data 510 to obtain the location result 550 of the gas fault.

As shown in FIG. 5, the location model may include a feature extraction layer 520 and a location prediction layer 540.

In some embodiments, the feature extraction layer 520 may process the second call consultation data 510 to obtain a second gas phenomenon feature 530. In some embodiments, the feature extraction layer 520 may include various feasible neural network models such as a graph neural network (GNN) model, a convolutional neural network (CNN) model, a deep neural network (DNN) model, or the like, or any combination thereof.

In some embodiments, the feature extraction layer 520 may include a plurality of feature extraction layers (e.g., a feature extraction layer a, a feature extraction layer b, etc.), and different feature extraction layers may respectively process the second call consultation data 510 of different data types to obtain the second gas phenomenon features 530 of different feature types. For example, the feature extraction layer a may process second call consultation data (text data) 511 and obtain a second gas phenomenon feature (text feature) 531.

As shown in FIG. 5, an input of the feature extraction layer 520 may include the second call consultation data 510 of different data types (e.g., the second call consultation data (text data) 511, the second call consultation data (voice data) 512, the second call consultation data (image data) 513, etc.).

In some embodiments, the first call consultation data 410 shown in FIG. 4 and the second call consultation data 510 shown in FIG. 5 may come from the call consultation data of the same user to be troubleshooted.

An output of the feature extraction layer 520 may include the second gas phenomenon features 530 of different feature types (e.g., the second gas phenomenon feature (text feature) 531, a second gas phenomenon feature (voice feature) 532, and a second gas phenomenon feature (image feature) 533, etc.).

The second gas phenomenon feature 530 refers to a feature reflecting data information contained in the second call consultation data 510. The second gas phenomenon feature 530 may be represented by a vector, and different elements in the vector represent different features in the second call consultation data. For example, the second gas phenomenon feature 530 may be (x, y, z). x represents a count of pieces of second consultation information, y represents a type of a question asked by a customer service, and z represents a proportion of negative answers to the questions asked to answers of the user to be troubleshooted.

More descriptions of the second consultation information and the second call consultation data may be found in FIG. 3 and its related descriptions thereof.

In some embodiments, the location prediction layer 540 may process the second gas phenomenon feature 530 to obtain the location result 550 of the gas fault. In some embodiments, the location prediction layer 540 may include various feasible neural network models such as the graph neural network (GNN) model, the convolutional neural network (CNN) model, the deep neural network (DNN) model, or the like, or any combination thereof.

In some embodiments, the location prediction layer 540 may process the plurality of second gas phenomenon feature 530 of different feature types to obtain the location result 550 of the gas fault.

As shown in FIG. 5, an input of the location prediction layer 540 may include second gas phenomenon features 530 of different feature types (e.g., the second gas phenomenon feature (text feature) 531, the second gas phenomenon feature (voice feature) 532, and the second gas phenomenon feature (image feature) 533).

In some embodiments, the input of the location prediction layer 540 may also include the first gas phenomenon feature 560. The first gas phenomenon feature 560 shown in FIG. 5 may be the same as the first gas phenomenon feature 430 shown in FIG. 4, which is not repeated here. In some embodiments, the first gas phenomenon feature 430 shown in FIG. 4 and the second gas phenomenon feature 530 shown in FIG. 5 may be features obtained by processing the call consultation information of the same user to be troubleshooted.

In some embodiments of the present disclosure, the first gas phenomenon feature may be used as the input of the location prediction layer, which may increase the features input into the location model, thereby helping to improve the accuracy of the location result generated by the location model.

An output of the location prediction layer 540 may include the location result 550 of the gas fault. For example, the output locating result 550 of the gas fault may be “a component of the gas cooker is damaged.”

More descriptions of the location result of the gas fault may be found in FIG. 2 and its related descriptions.

In some embodiments, the output of the feature extraction layer 520 may be the input of the location prediction layer 540, and the location model may be obtained through joint training of the feature extraction layer 520 and the location prediction layer 540.

In some embodiments, second sample data of the joint training may include sample second call consultation data of different data types and sample first gas phenomenon features of different feature types, and a second label corresponding to the second sample data may be a location result of a sample gas fault. The sample second call consultation data may be represented by a vector. The dimension of the vector may be set in advance manually or by the system. Each element in the vector corresponds to a question. A specific numerical value of the element may indicate the answer of the user to be troubleshooted to the question, and if there is no such question, it is represented by 0. More description of representing the second call consultation data using the vectors may be found in FIG. 2, FIG. 3 and their related descriptions. The second sample data may be obtained based on historical data, and the second label may be determined by manual labeling or automatic labeling. The sample first gas phenomenon features of different feature types may be obtained based on a pre-location model. More descriptions of the pre-location model may be found in FIG. 4 and its related descriptions.

During training, the sample second call consultation data of different data types may be input into a corresponding initial feature extraction layer to obtain the second gas phenomenon features of different feature types output by the corresponding initial feature extraction layer. The second gas phenomenon features of different feature types and the sample first gas phenomenon features of different feature types may be input into an initial location prediction layer as training sample data to obtain the location result of the gas fault output by the initial location prediction layer. A loss function may be constructed based on the location result of the sample gas fault and the location result of the gas fault output by the location prediction layer, and parameters of the feature extraction layer and the location prediction layer may be updated synchronously. Through parameter updating, a trained feature extraction layer and location prediction layer may be obtained.

In some embodiments of the present disclosure, the second call consultation data may be processed through the location model, and the location result of the gas fault may be obtained, which can ensure the accuracy of the generated location result of the gas fault. Different feature extraction layers may process the second call consultation data of different data types, which can improve the efficiency of the location model in processing large amounts of data. The first gas phenomenon features may also be used as the input of the location model, which can increase the features input into the location model and the sample data of the training the location model, so that the trained location model can be more in line with the actual needs, and the generated location result of the gas fault can be more accurate.

FIG. 6 is a flowchart illustrating an exemplary process for generating a location result based on gas association data and call consultation data according to some embodiments of the present disclosure. In some embodiments, the process 600 may be executed by a processor in a smart gas data center 133. As shown in FIG. 6, the process 600 may include the following operations.

In 610, obtaining gas association data.

The gas association data refers to gas data associated with a fault situation of a user to be troubleshooted. For example, the gas association data may be call consultation data of other gas users satisfying a preset condition. The preset condition may be set manually or by the system. For example, the preset condition may be that a similarity between the fault conditions of other gas users and the fault condition of the user to be troubleshooted satisfies a certain threshold (e.g., 80%), and the similarity may be determined based on fault features of other gas users and a fault feature of the user to be troubleshooted.

In some embodiments, the gas association data may come from association users with different association degrees of gas fault, and the association degree of gas fault may be determined based on a matching degree of at least one gas-related feature between the association user and the user to be troubleshooted.

The association users refer to other gas users associated with the user to be troubleshooted. For example, the association user may be a gas user whose fault condition may be the same or similar to that of the user to be troubleshooted. As another example, the association user may be a gas user who shares the same gas delivery system or the same type of gas terminal device as the user to be troubleshooted.

In some embodiments, the same user to be troubleshooted may correspond to one or more association users.

The association degree of gas fault refers to an association degree between the association user and the user to be troubleshooted, and the association degree of gas fault may be represented by different levels. For example, the association degree of gas fault may be divided into levels I-V. The higher the level, the greater the association degree of gas fault, and the closer the association degree between the association user and the user to be troubleshooted.

In some embodiments, the association degree of gas fault may be determined based on the matching degree of the at least one gas-related feature between the association user and the user to be troubleshooted. For example, the gas-related feature may include a gas terminal feature, a gas pipeline feature (e.g., a size and material of the gas pipeline, etc.), etc.

In some embodiments, the gas-related feature may also include a gas fault time feature, a gas fault space feature, a historical gas fault distribution, etc. More descriptions of gas fault time feature, the gas fault space feature, and the historical gas fault distribution may found in the sub-operation 611 to the sub-operation 613 below.

The matching degree refers to a matching degree of at least one gas-related feature between the gas user and the user to be troubleshooted. The matching degree may be represented by a vector. For example, the matching degree may be (0.1, 0.2, 0.3), which means that the matching degree of the gas terminal feature is 10%, the matching degree of the gas pipeline feature is 20%, and the matching degree of the gas fault time feature is 30%. The matching degree may also be represented by a final value, for example, an average value may be calculated based on the matching degrees of the three gas-related features to obtain a final matching degree of 20%. The more gas-related features with a matching degree greater than 0, and the larger the value of the matching degree, the greater the association degree of gas fault.

In some embodiments, the processor in the smart gas management platform 130 may process the at least one gas-related feature between the association user and the user to be troubleshooted by modeling or various feasible feature analysis manners to determine the matching degree of the at least one gas-related feature between the association user and the user to be troubleshooted.

In some embodiments, the processor in the smart gas management platform 130 may construct a feature vector based on the at least one gas-related feature (e.g., the gas terminal feature, the gas pipeline feature, etc.). The feature vector may be constructed based on the at least one gas-related feature. For example, the feature vector q may be constructed based on the gas terminal feature (x, y, z), where the gas terminal feature (x, y, z) may indicate that a type of a gas terminal is x, a service life of the gas terminal is y, and a count of historical failures of the gas terminal is z. As another example, the feature vector k may be constructed based on the gas terminal feature (x, y, z) and the gas pipeline feature (h, i, j), where the meaning of the gas terminal feature (x, y, z) is the same as above, and the gas pipeline feature (h, i, j) can indicate that a size of a gas pipeline is h, a material of the gas pipeline is i, and a count of maintenance times of the gas pipeline is j.

The processor in the smart gas management platform 130 may construct an association vector based on the at least one gas-related feature of the association user and construct a vector to be matched based on the at least one gas-related feature of the user to be troubleshooted through the above manner of constructing the feature vector, calculate a vector distance (e.g., the cosine distance, etc.) between the association vector and the vector to be matched, and use a calculation result as the matching degree of the at least one gas-related feature between the association user and the user to be troubleshooted.

In some embodiments, the processor in the smart gas management platform 130 may determine the association degree of gas fault between the association user and the user to be troubleshooted based on the matching degree of the at least one gas-related feature between the association user and the user to be troubleshooted. For example, the matching degree may be divided into different intervals, and each interval corresponds to the level of association degree of gas fault. For example, the matching degree may be divided into different intervals, and each interval corresponds to the level of the association degree of gas fault. If the matching degree of 50-60% corresponds to level I of the association degree of gas fault, the matching degree of 70-80% corresponds to level III of the association degree of the gas fault, etc., and an interval into which the obtained matching degree falls may be calculated, the association degree of gas fault corresponding to the interval may be used as the association degree of gas fault between the association user and the user to be troubleshooted.

In some embodiments, the processor in the smart gas management platform 130 may determine the association user based on the association degree of gas fault. For example, the gas user with the association degree of gas fault may be used as the association user. As another example, the gas user with the association degree of gas fault greater than a threshold (e.g., level III) may be used as the association user.

In some embodiments of the present disclosure, the gas association data may be determined by the association degree of gas fault, which can ensure that the gas association data is consistent with the actual fault situation of the user to be troubleshooted. The association degree of gas fault may be determined by the at least one gas-related feature, which can determine the association degree between the association user and the user to be troubleshooted from various factors, thereby further enhancing the accuracy of determining the association degree of gas fault.

In some embodiments, the processor in the smart gas management platform 130 may obtain the gas association data through the sub-operation 611 to the sub-operation 613.

In 611, obtaining a gas fault time feature and a gas fault space feature of the user to be troubleshooted.

The gas fault time feature refers to a gas fault feature related to time information. For example, the gas fault time feature may include a time when the gas user starts a gas fault consultation, a count of gas user consultations in history, a duration of each consultation, an interval between each two consultations, etc.

The gas fault space feature refers to a gas fault feature related to space information. For example, the gas fault space feature may include a detailed address of the gas user, information of a gas household pipeline corresponding to the gas user, information of a gas upstream transmission pipeline corresponding to the gas user, etc.

In some embodiments, the gas fault time feature and the gas fault space feature may be obtained from the smart gas data center 133. In some embodiments, the gas fault time feature and the gas fault space feature may be stored in the smart gas data center 133, and the gas fault time feature and the gas fault space feature may be updated in real time or periodically (e.g., monthly) manually or by the system. For example, when the user to be troubleshooted consults about the gas fault, the processor in the smart gas data center 133 may update the gas fault time feature in real time. As another example, when performing regular (e.g., monthly) inspections on the gas pipeline, the gas staff may manually input and update the gas fault space feature.

In 612, determining an association user associated with the user to be troubleshooted through a preset matching degree based on the gas fault time feature and the gas fault space feature.

The preset matching degree refers to a preset matching degree used to determine whether a gas user can be the association user of the user to be troubleshooted. The preset matching degree may be a specific numerical value. For example, if the preset matching degree is 80%, and when the matching degree between the gas fault time feature and the gas fault space feature of the gas user and the gas fault time feature and the gas fault space feature of the user to be troubleshooted is greater than 80%, the gas user may be used as the association user of the user to be troubleshooted.

In some embodiments, the preset matching degree may be related to a gas location complexity. The greater the gas location complexity, the greater the preset matching degree. More descriptions of the gas location complexity may be found in FIG. 3 and its related descriptions.

In some embodiments of the present disclosure, the gas location complexity may be introduced as a factor affecting the preset matching degree. The greater the gas location complexity is, the more difficult it is to generate a location result of a gas fault. At this time, the preset matching degree may be correspondingly improved, which can make a judgment condition for determining the association user stricter, thereby ensuring the accuracy of the obtained gas association data.

In some embodiments, the processor in the smart gas data center 133 may determine the association user associated with the user to be troubleshooted through the preset matching degree based on the gas fault time feature, the gas fault space feature and the historical gas fault distribution. For example, if the preset matching degree is 80%, and when the matching degree between the gas fault time feature, the gas fault space feature, and the historical gas fault distribution of the gas user and the gas fault time feature, the gas fault space feature, and the historical fault distribution of the user to be troubleshooted is greater than 80%, the gas user may be used as the association user of the user to be troubleshooted.

In some embodiments, the processor in the smart gas management platform 130 may construct the feature vector based on gas fault time feature, the gas fault space feature, and the historical gas fault distribution, construct the association vector based on the gas fault time feature, the gas fault space feature, and the historical gas fault distribution of the gas user, construct the vector to be matched based on the gas fault time feature, the gas fault space feature, and the historical fault distribution of the user to be troubleshooted, calculate the vector distance (e.g., the cosine distance, etc.) between the association vector and the vector to be matched, and use a calculation result as the matching degree between the gas fault time feature, the gas fault space feature, and the historical gas fault distribution of the gas user and the gas fault time feature, the gas fault space feature, and the historical fault distribution of the user to be troubleshooted.

The manner of constructing the feature vector, the association vector, and the vector to be matched is the same as the manner of constructing the feature vector, the association vector, and the vector to be matched based on the at least one gas-related feature above, which is not repeated here.

In some embodiments, the preset matching degree may be also related to the historical gas fault distribution. The more types of gas faults that have occurred in history, the greater the gas location complexity and the greater the preset matching degree. More descriptions of the historical gas fault distribution may be found in FIG. 3 and its related descriptions.

In 613, obtaining the call consultation data of the association user and using the call consultation data of the association user as the gas association data.

In some embodiments, the processor in the smart gas management platform 130 may obtain the call consultation data of the association user from the smart gas data center 133 based on the association user. In some embodiments, the call consultation data of the association user may be updated periodically (e.g., monthly).

In 620, generating the location result of the gas fault based on the call consultation data and the gas association data.

More descriptions of the location result may be found in FIG. 2 and its related descriptions.

In some embodiments, the processor in the smart gas management platform 130 may process the call consultation data and the gas association data through modeling or various feasible data analysis manners to generate the location result of the gas fault.

In some embodiments, the processor in the smart gas management platform 130 may use the gas association data and the call consultation data together as new call consultation data of the user to be troubleshooted, generate the location result of the gas fault by processing the new call consultation data based on the method described in FIGS. 2-5 above.

In some embodiments, the processor in the smart gas management platform 130 may use the gas association data as one of the reference factors during the process of processing the call consultation data through the method described in FIGS. 2-5 above and combine with the call consultation data to generate the location result of the gas fault. In some embodiments, the processor in the smart gas management platform 130 may use the gas association data and the association degree of the gas fault together as the reference factors during the process of processing the call consultation data through the methods described in FIGS. 2-5 above and combine with the call consultation data to generate the location result of the gas fault. For example, the gas association data and the association degree of the gas fault may be used as inputs of the pre-location model and the location model.

In some embodiments of the present disclosure, the gas association data may be obtained and the location result of the gas fault may be generated based on the gas association data combined with the call consultation data, which can help the user to determine the location result of the gas fault combined with the situations of other gas users associated with the user to be troubleshooted when the user to be troubleshooted feedbacks that the gas fault consultation question is not efficient or accurate enough. The associated user may be determined through the restrictive condition such as the association degree of the gas fault, the preset matching degree, etc., which can improve the accuracy of determining the association user and ensure the validity of the gas association data of the association user.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing data of a call center of smart gas, executed by a processor in a smart gas management platform of an Internet of Things system for managing data of a call center of smart gas, comprising:
constructing call consultation data of a user to be troubleshooted based on consultation information of the user to be troubleshooted collected by a customer service from a user terminal through a network;
generating a location result of a gas fault based on the call consultation data; and
generating a fault handling plan based on the location result of the gas fault and sending the fault handling plan to the user terminal.

2. The method of claim 1, wherein the Internet of Things system for managing data of a call center of smart gas further comprises: a smart gas user platform, a smart gas service platform, a smart gas sensor network platform, and a smart gas object platform;
the smart gas user platform is configured to collect the consultation information of the user to be troubleshooted from the user terminal through the network and send the consultation information to the smart gas management platform through the smart gas service platform; and
the smart gas service platform is configured to send the fault handling plan to the smart gas user platform.

3. The method of claim 1, wherein the customer service includes an intelligent customer service and a manual customer service, the consultation information includes first consultation information and second consultation information, and the call consultation data includes first call consultation data and second call consultation data; and
the generating the location result of the gas fault based on the call consultation data includes:
constructing the first call consultation data based on the first consultation information of the user to be troubleshooted collected by the intelligent customer service, wherein the first call consultation data includes data related to a directly observed gas phenomenon feature;
generating a pre-location result of the gas fault based on the first call consultation data;
determining a target manual customer service based on the pre-location result of the gas fault;
constructing the second call consultation data based on the second consultation information of the user to be troubleshooted collected by the target manual customer service, wherein the second call consultation data includes data related to a gas phenomenon feature after a detection operation is performed; and
generating the location result of the gas fault based on the second call consultation data.

4. The method of claim 3, wherein
the constructing the first call consultation data based on the first consultation information of the user to be troubleshooted collected by the intelligent customer service comprises:
obtaining the first consultation information by inquiring the user to be troubleshooted based on a first question set through the intelligent customer service; and
constructing the first call consultation data based on the first consultation information, wherein the first question set is determined based on a preset question; and
the constructing the second call consultation data based on the second consultation information of the user to be troubleshooted collected by the target manual customer service comprises:
obtaining the second consultation information by inquiring the user to be troubleshooted based on a second question set through the target manual customer service; and
constructing the second call consultation data based on the second consultation information, wherein the second question set is related to a feature of a gas terminal of the user to be troubleshooted.

5. The method of claim 3, wherein the determining a target manual customer service based on the pre-location result of the gas fault comprises:
generating a gas location complexity based on the pre-location result of the gas fault; and
determining the matching target manual customer service based on the gas location complexity.

6. The method of claim 5, wherein the gas location complexity is also related to a historical gas fault distribution of the user to be troubleshooted.

7. The method of claim 1, wherein the generating a location result of a gas fault based on the call consultation data further comprises:
obtaining gas association data; and
generating the location result of the gas fault based on the call consultation data and the gas association data.

8. The method of claim 7, wherein the gas association data comes from association users with different association degrees of gas fault, and the association degree of gas fault is determined based on a matching degree of at least one gas-related feature between the association user and the user to be troubleshooted.

9. The method of claim 7, wherein the obtaining gas association data comprises:
obtaining a gas fault time feature and a gas fault space feature of the user to be troubleshooted;
determining an association user associated with the user to be troubleshooted through a preset matching degree based on the gas fault time feature and the gas fault space feature; and
obtaining the call consultation data of the association user and using the call consultation data of the association user as the gas association data.

10. The method of claim 9, wherein the preset matching degree is related to a gas location complexity.

11. The method of claim 9, wherein the determining an association user associated with the user to be troubleshooted through a preset matching degree based on the gas fault time feature and the gas fault space feature comprises:
determining the association user associated with the user to be troubleshooted through the preset matching degree based on the gas fault time feature, the gas fault space feature, and a historical gas fault distribution.

12. An Internet of Things system for managing data of a call center of smart gas, comprising: a smart gas user platform, a smart gas service platform, a smart gas management platform, a smart gas sensor network platform, and a smart gas object platform, wherein
the smart gas user platform is configured to collect consultation information of a user to be troubleshooted from a user terminal through a network and send the consultation information to the smart gas management platform through the smart gas service platform;
the smart gas management platform is configured to:
construct call consultation data of the user to be troubleshooted based on the consultation information;
generate a location result of a gas fault based on the call consultation data; and
generate a fault handling plan based on the location result of the gas fault and send the fault handling plan to the user terminal; and
the smart gas service platform is configured to send the fault handling plan to the smart gas user platform.

13. The Internet of Things system of claim 12, wherein the customer service includes an intelligent customer service and a manual customer service, the consultation information includes first consultation information and second consultation information, and the call consultation data includes first call consultation data and second call consultation data; and
a processor in the smart gas management platform is further configured to:
construct the first call consultation data based on the first consultation information of the user to be troubleshooted collected by the intelligent customer service, wherein the first call consultation data includes data related to a directly observed gas phenomenon feature;
generate a pre-location result of the gas fault based on the first call consultation data;
determine a target manual customer service based on the pre-location result of the gas fault;
construct the second call consultation data based on the second consultation information of the user to be troubleshooted collected by the target manual customer service, wherein the second call consultation data includes data related to a gas phenomenon feature after a detection operation is performed; and
generate the location result of the gas fault based on the second call consultation data.

14. The Internet of Things system of claim 13, wherein the processor in the smart gas management platform is further configured to:
obtain the first consultation information by inquiring the user to be troubleshooted based on a first question set through the intelligent customer service;
construct the first call consultation data based on the first consultation information, wherein the first question set is determined based on a preset question;
obtain the second consultation information by inquiring the user to be troubleshooted based on a second question set through the target manual customer service; and
construct the second call consultation data based on the second consultation information, wherein the second question set is related to a feature of a gas terminal of the user to be troubleshooted.

15. The Internet of Things system of claim 13, wherein the processor in the smart gas management platform is further configured to:
generate a gas location complexity based on the pre-location result of the gas fault; and
determine the matching target manual customer service based on the gas location complexity.

16. The Internet of Things system of claim 12, wherein the processor in the smart gas management platform is further configured to:
obtain gas association data; and
generate the location result of the gas fault based on the call consultation data and the gas association data.

17. The Internet of Things system of claim 16, wherein the gas association data comes from association users with different association degrees of gas fault, and the association degree of gas fault is determined based on a matching degree of at least one gas-related feature between the association user and the user to be troubleshooted.

18. The Internet of Things system of claim 16, wherein the processor in the smart gas management platform is further configured to:
obtain a gas fault time feature and a gas fault space feature of the user to be troubleshooted;
determine an association user related to the user to be troubleshooted through a preset matching degree based on the gas fault time feature and the gas fault space feature; and
obtain the call consultation data of the association user and use the call consultation data of the association user as the gas association data.

19. The Internet of Things system of claim 18, wherein the processor in the smart gas management platform is further configured to:
determine the association user related to the user to be troubleshooted through the preset matching degree based on the gas fault time feature, the gas fault space feature, and a historical gas fault distribution.

20. A non-transitory computer-readable storage medium storing computer instructions, wherein when the computer instructions are executed by a processor, the method for managing data of a call center of smart gas of claim 1 is implemented.
